(19) United States
(12) Patent Application Publication
(10) Pub. No.: US 2006/0176831 A1
(43) Pub. Date: Aug. 10, 2006

(54) Methods and apparatuses for selecting users to join a dynamic network conversation

(76) Inventors: Joel Kenneth Greenberg, Gladwyne, PA (US); Allen Corbit Beebe, Malvern, PA (US); David Gabriel Siracusa, Newtown Square, PA (US)

Correspondence Address: DLA PIPER RUDNICK GRAY CARY US LLP, P. O. BOX 9271, RESTON, VA, 20195, US

(21) Appl. No.: 11/050,861

(22) Filed: Feb. 7, 2005

(51) Int. Cl. H04L 12/16; H04Q 11/00

(52) U.S. Cl. 370/260

(57) ABSTRACT

The embodiments of the invention include a method of selecting users to join a network conversation comprising determining a subject of a network conversation and correlating the subject with subject matter criteria to determine at least one selected user who is or would be interested in the conversation.

### FIELD OF THE INVENTION

The present invention relates generally to communication networks, and more particularly to selecting users to join a communication dynamic network conversation (a.k.a network conversation).

### BRIEF DESCRIPTION OF DRAWINGS

A more complete appreciation of embodiments of the invention will be readily obtained by reference to the following detailed description when considered in conjunction with the accompanying drawings, wherein

FIG. 1 is an overview block diagram illustrating the various components of a network communication system according to embodiments of the invention.

FIG. 2 is a block diagram illustrating a client-server environment for a data communication network according to embodiments of the invention.

FIG. 3 is a block diagram illustrating a client-server environment for a communication network according to embodiments of the invention.

FIG. 4 is a flow diagram illustrating a user request for establishing a network conversation according to various embodiments of the invention.

### DETAILED DESCRIPTION OF SEVERAL EMBODIMENTS

Embodiments of the invention include apparatuses and embodiments of several methods of selecting users to join a dynamic network conversation.

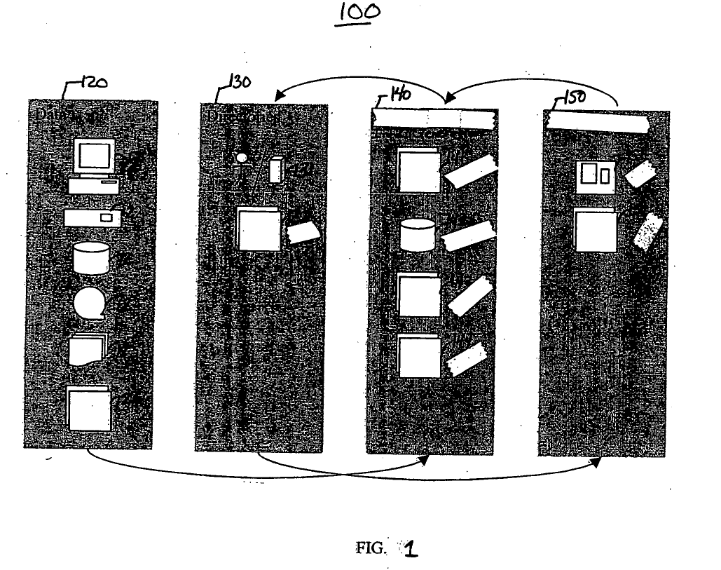

FIG. 1 is an overview block diagram illustrating various components of a network communication system according to embodiments of the invention. In general, a network communication system 100 comprises information sources such as data sources 120 and directories 130 that may be utilized by various information generating and usage components, 140 and 150, respectively. There are a variety of sources from which various types of data may be gathered. As used herein, “data” may include any information, human or machine-readable, that may be useful to facilitate a network conversation between users. For example, and not as a limitation, data may include any signal or signal impression upon which intelligence may be detected and/or recovered, such as an electromagnetic wave or an electrostatic charge. Data may include information transmitted from one place to another such as a communication signal which traverses a computer network and/or stored information such as a record stored on a computer disk. Data may include messages and message threads such as instant messaging messages, text messages and e-mail messages. Data may also include excerpts, segments or portions of messages or message threads. As such, there are a variety of sources from which data may be garnered for the purposes herein. For example, the data sources 120 include fixed disk devices for personal computers 121, portable or flexible storage devices 122 such as flash memory, tapes, CD/DVD or diskettes, hardware or software databases 123, sequential streams 124, document repositories 25 such as hard and/or soft copy storage, transient storage, regulatory compliance storage and other media 126.

The data sources 120 may be “mined,” or monitored, using various parsing technologies for related data. In particular, the data sources 120 such as network conversations may be mined for discrete “subject matter.” A network conversation may generally include one or more related transmissions, or segments of transmissions, between users in a network. For example, a network conversation may comprise an address for a conversation, a subject line of a conversation and/or at least a segment of the dialogue of a conversation. A network conversation may further comprise one or more different types of transmissions (e.g., voice, video, data) that may be transmitted contemporaneously and/or stored. For example, a network conversation may include one or more public or private email messages between users facilitated through an email platform. In another example, a network conversation may include one or more instant messages between users facilitated through an instant messaging platform. Still other examples of network conversations include multiple user chat rooms, telephone conversations, teleconferences, videoconferences, Webconferences, interactive gaming sessions, and streaming data transmissions. In one embodiment, network conversations are divided into discrete time segments for managing the storage and retrieval of such conversations. As will be described further below, network conversations may serve as a resource for selecting users to join current and/or future network conversations based on various subject matter criteria.

The directories 130 store data that may be of specific relevance to a particular network and/or application. Typical directories 130 include classifications of human and non-human resources 131 and network specific directory services 132. For example, human resources 131 may include personal information about the users of a network such as their first and last name, date of birth, address, position, network access device, network configuration preferences, security profile, curriculum vitae, resume and other information. Examples of a directory service are the Microsoft Active Directory and the Novell Directory Service. While these directory services are mentioned due to the inventor's familiarity of their operation, other directory services are equally suitable for implementing the embodiments herein.

The information generation components 140 may update or add new information to the directories 130 so that they may provide current information for various operations as will be described in detail below. The information generation components 140 include applications for mining and indexing data from the data sources 120 according to various parameters. For example, a natural language processor 141 mines network conversations from the data sources 120 for predetermined subject matter criteria by parsing contemporaneous or stored conversation dialogue. The correlations between subject matter criteria and those participating in the conversations may then be stored in an indexed database 142. The indexed database 142 may catalogue the mined data correlations based on dialogue content and index the mined data correlations in relation to the predetermined subject matter criteria. For example, if a predetermined subject matter criterion relates to dogs, a mined network conversation may be indexed with an assigned probability of whether the conversation relates to dogs. In essence, the indexed database 142 functions as a subject matter to user catalog that may be accessible to various applications for facilitating network conversations. Alternatively, the functions for creating an indexed database 142 may be performed in real time for applications that involve, for example, selecting users for association with contemporaneous conversations, as is well known in the art. For example, search engines, such as the Google search engine by Google Inc., select objects (e.g. Websites) that correlate with a user query.

A publisher 143 utilizes information from the indexed database 142 and/or the data. sources 120 to generate an association between a selected user and subject matter. For example, a publisher 143 may generate a roster or user list of users with common subject matter interests. In another example, a publisher 143 may be an instant messaging “bot” designed for providing various information and services, including inviting a user or list of users with common subject matter interests to join a roster. In one embodiment, each user has a roster that defines groups and/or contacts. The groups and/or contacts may be entered manually or all or part of the roster may be maintained with an automated roster generator. In another example, a publisher 143 may automatically establish, or invite a selected user to manually establish, a network conversation between users with common subject matter interests. For example, a publisher 143 may establish a conversation when a user broadcasts a query about a specific subject. Establishing a conversation may include, for example, the generation of a temporary or permanent chat room or a teleconference populated by selected users with common interests. In other embodiments, a publisher 143 may update a roster of users by utilizing the indexed database 142, the data sources 120, and/or web services discovery technology such as UDDI and DISCO 144. The updated roster may then be stored in a database.

The usage components 150 comprise the various components that interface with the various users in a network. For example, the usage components 150 may include client applications 151, which may, for example, include a user interface as well as applications that may be executable on a client device such as a personal computer, personal digital assistant, cellular phone, networked telephone, video monitor, gaming console and/or any combination of such devices. The client applications 151 may facilitate the generation of a network conversation and/or the generation of user rosters for a particular subject. A processor 152, which may be linked to the client applications 151 via a network interface, such as a wired or wireless transceiver, may execute various user requests received from the client applications 151. For example, the processor 152 may be located within one or more servers that are accessible via a plurality of client devices running applications 151 that facilitate network conversations between users. In operation, the processor 152 may receive a user request from a client application 151 via a network interface. The processor 152 may then access one or more of the various information generating components 140, which in turn may access one or more directories 130, to generate a user roster of associated users and/or select users for association with a network conversation based on subject matter criteria.

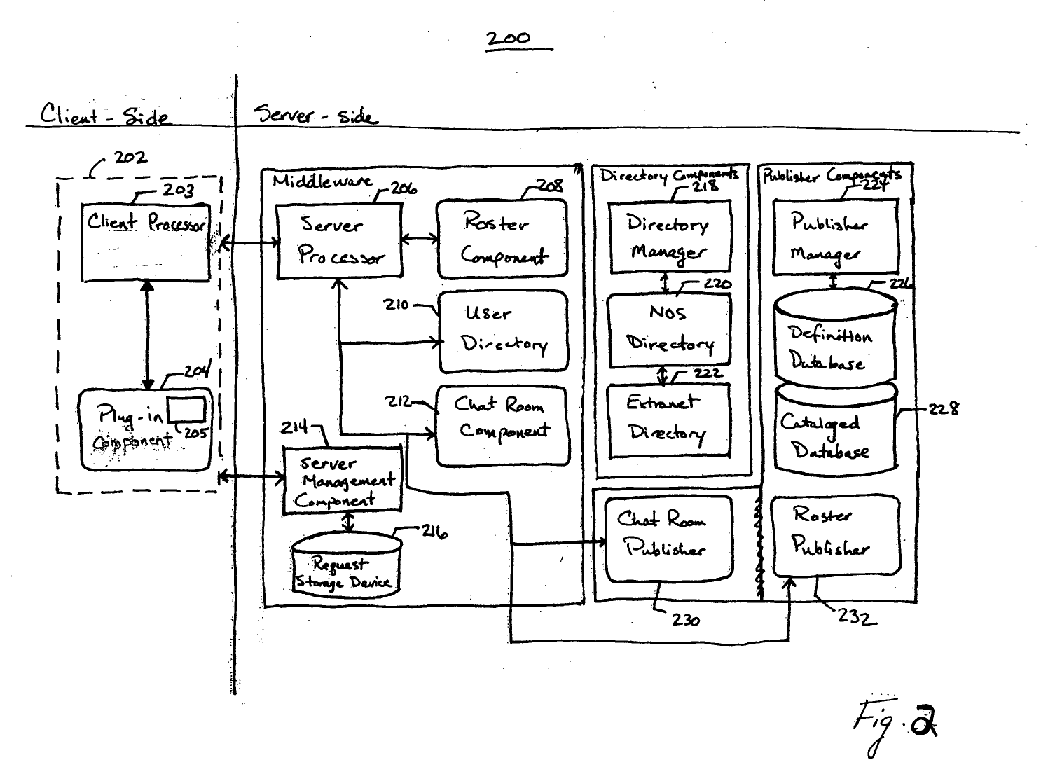

FIG. 2 is a block diagram illustrating a client-server environment for a data communication network according to embodiments of the invention. The network 200 comprises “client” side operations and “server” side operations. However, it should be noted that in various embodiments client components may perform operations designated in other embodiments as operations performed by server components and vice versa. Therefore, any of the operations described herein may be performed by a client component or a server component or any combination of client and server components. In addition, the network 200 may include a plurality of client devices and servers that may distribute, for example, the various client side operations between one or more client devices and likewise, the various server side operations between one or more servers. As such, the network 200 as shown is in many cases simplified for the purposes of illustration, however, it should be noted that many other configurations of the network 200 are possible.

In one embodiment, a user accesses the network 200 via a client device 202. For example, the client device 202 may include a network interface (not shown) such as a wireless transceiver or other connection device. The client device 202 may be any device that may access a network for the purpose of facilitating a network conversation. For example, the client device 202 may be a personal computer, a personal digital assistant, cellular telephone, land line telephone, video monitor, gaming console and/or any combination of such devices.

The client device 202 further comprises a client processor 203 and at least one plug-in component 204 which, in one embodiment includes a dedicated plug-in processor 205. In one embodiment, the plug-in application 204 provides an interface between the client device 202 and a user for the client processor 203 to execute certain functions, including the initiation of a network conversation. The plug-in application 204 may be a software component that includes, for example, a graphical user interface. The graphical user interface may be programmed to accept particular inputs from a user and to output a presentation of a desired result. For example, the graphical user interface may comprise fields that may be populated by a user to provide subject matter criteria for establishing a network conversation. In another example, when the network conversation is established a user interface may facilitate the conversation by displaying or otherwise presenting the network conversation to the user. It should be noted that while the plug-in component 204 is described herein to be implemented as a software program, in other equally suitable embodiments the plug-in application 204 may be implemented by any combination of hardware, software and/or firmware. The plug-in component 204 may also bundle the functionality to establish a network conversation with a variety of other functions. In one embodiment, the plug-in component 204 is integrated into a messaging application, such as the Exodus or Gabber instant messaging client applications for the Jabber instant messaging platform. The Jabber instant messaging platform and Exodus and Gabber client applications are mentioned herein because of the inventor's familiarity with the Jabber platform, however, those skilled in the art will note that any of a variety of communication network platforms are suitable, including various other instant messaging platforms.

A server processor 206 receives instructions from the client device 202 via a network interface. Alternatively, the server processor 206 may receive instructions directly via a server user interface (not shown) or may generate automated instructions. In one embodiment, the server side operations may be divided into operations performed by distinct components. For example, it should be noted that the server side operations may be implemented by one or more executable software program instructions that may be executed by one or more components in addition to the server processor 206.

In one embodiment, the server processor 206 executes instant messaging software instructions received from an instant messaging platform, such as, for example, the Jabber instant messaging platform. In addition, the server processor 206 may access various components for executing instructions including, for example, a roster component 208 which may generate a user roster based on the request from the user, a user directory 210 which may be utilized to locate other users connected to the network, and a chat room component 212 which may generate a dynamic chat room of selected users.

Alternatively, a server management component 214 may receive instructions from the client device via a network interface. The server management component 214 may receive and classify client requests and then store them in a storage device 216 for possible future reference by the requesting user and/or other users linked to the network. For example, a user may wish to publish a particular request to initiate a network conversation at a future date. In such case, the server management component 214 may publish the request for other users who are or may be interested in the request subject matter and maintain the parameters of the request in the request storage device 216.

In one embodiment, the server processor 206, roster component 208, user directory 210, chat room component 212, request management component 214 and request storage device 216 comprise the server components, which may be referred to as the “middleware” components. The middleware components in communication with the server processor 206 may access various directory and publisher components to execute various user requests. In one embodiment, the server processor 206 may access user directory information via a directory manager 218. The directory manager 218 manages user information that may be used to select a particular user for association with network conversation. For example, the directory manager 218 is accessed via Light Weight Directory Access Protocol (LDAP) to search for a particular user. The user directory 210 will use the directory manager 218 and user profile information in an NOS directory 220 and/or an Extranet directory 222 for users external to the network. For example, a user request executed by the server processor 206 may require the addition of a selected user to a dynamic chat room. In such case, the server processor 206 may access the chat room component 212. The chat room component 212 may in turn access the user directory manager 218 for users who are or may be interested in the request subject matter. The user directory 210 will use the directory manager 218 may then access the NOS directory 220 and/or the Extranet directory 222 wherein a user identity is associated with subject matter categories, words and/or other identifiers, for compatible users. The chat room component 212 may then dynamically update a chat room by selecting from the returned compatible users. Likewise, the roster component 208 may dynamically update the user roster of the requesting user by adding the selected users. This scenario may be used, for example, when the requesting user has a previously established user roster such as a manually entered user roster for an instant messaging system. Alternatively, this process may be used to deselect a user from a chat room and/or user roster if the profile of a previously selected user is no longer compatible.

The publisher components supply user data for the directory components. The publisher manager 224 may index, analyze and/or extract information from user conversations that might be utilized to determine weighted associations among users and subject matter criteria. These associations are stored in the cataloged database 228. The publisher manager 224 receives subject matter criteria from a definition database 226. For example, the subject matter criteria stored in the definition database 226 may be predetermined by a user. Alternatively, the subject matter criteria may be generated by the publisher manager 224 based on a user request. For example, a user may request a conversation with users who have knowledge in a general topic. The publisher manager 224 may then generate subject matter criteria based on the user request and/or additional information from the requesting user.

The publisher manager 224 may then search the stored correlations in the catalogued database 228 for network conversations that may match the subject matter criteria. Based on the results of such a search, the server processor 206 may call a chat room publisher 230 and/or a roster publisher 232 to establish a new chat room conversation and/or user roster by, for example, inviting selected users to participate. This scenario may be used, for example, when the requesting user does not have a previously established user roster. In one embodiment, the chat room publisher 230 and the roster publisher 232 may manage the chat room sessions and user rosters for a plurality of users on the network, including the chat rooms and user rosters created by the chat room and roster components, 208 and 212 respectively.

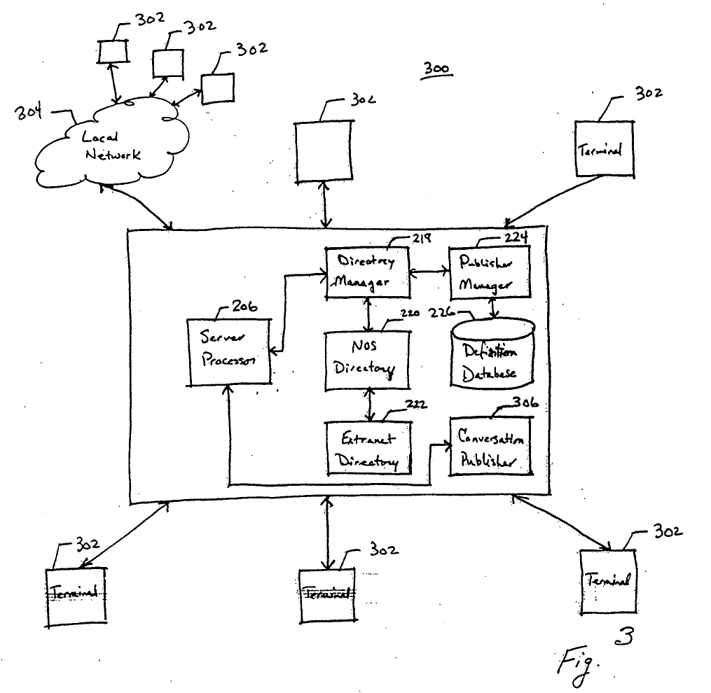

FIG. 3 is a block diagram illustrating a communication network according to embodiments of the invention. In this embodiment, the storage-based components are de-emphasized in favor of contemporaneous data mining capabilities such as voice recognition and natural language processing. For example, the network 300 may facilitate a network conversation between user terminals 302 in a teleconferencing network wherein the content of various voice conversations may be mined for subject matter that could in turn be used to add or invite a user to join a particular teleconference while it is in progress. In another example, the terminals 302 may be instant messaging terminals or gaming consoles where user message dialogue or gaming actions may be mined to automatically add users to a chat room conversation or a gaming tournament. In one embodiment, the terminals 302 may comprise a hierarchical and/or security application for allowing a user to choose whether they wish to be automatically added to a network conversation.

A terminal 302 need not be directly connected to the server side for automatically selecting users to join a network conversation. The terminals may be connected to a local network 304 such as, for example, an intra-office telephone network. In turn, the local network 304 may communicate with the server to process a user request.

The server side may include the server processor 206, directory manager 218 and associated directories 220 and 222, as well as the publisher manager 224 and definition database 226. The functions of these components are similar to those described in FIG. 2 above. In addition, the publisher manager 224 may include contemporaneous mining technologies such as voice recognition, natural language processing, artificial intelligence programming and/or a combination of such capabilities and others which may be known to those skilled in the art. The conversation publisher 306 is operable to automatically associate a selected user, as identified by the publisher manager 224 via a cataloged database of user identities, to a network conversation.

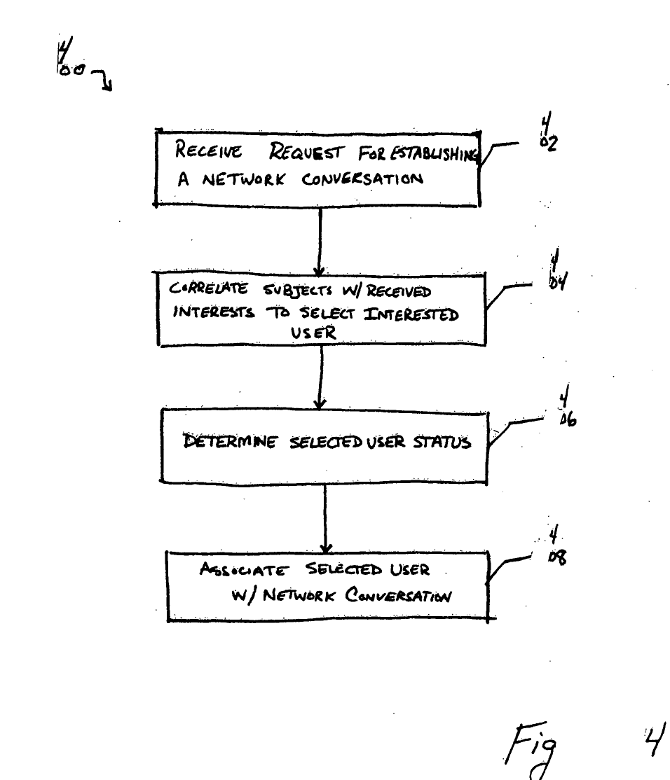

FIG. 4 is a flow diagram illustrating a user request for establishing a network conversation according to various embodiments of the invention. It should be noted that while the various processes described herein are described as being performed by a processor on a server, various processes and/or all of the processes so described may be implemented by one or more processors located in one or more servers and/or clients and that such embodiments, while not included herein for the purposes of simplification and ease of understanding, are equally as effective for implementing the invention as the embodiments described below.

As such, in operation, at 402 the server processor 206 receives a request for establishing a network conversation from a user via a network interface from a client device 202 associated with a network at step 400. Alternatively, the server processor 206 may receive an automated request for establishing a network conversation based on, for example, the subject matter of a previous and/or active network conversation, thereby extending the scope of an active network conversation. The request may be a natural language request or in another format such as, for example, machine-readable format. At 404, the server processor 206 correlates conversation subjects with users to select one or more users who are or may be interested in the conversation subject matter. For example, as described above for a network as in FIG. 2, the server processor 206 may access the various middleware, user directory and/or publisher services as necessary to select a user who is or would be interested in the subject matter criteria of the requesting user. At 406, the server processor 206 determines that status of the one or more selected users. For example, the server processor 206 may determine that a selected user, while interested in the conversation subject, may be inaccessible to the requesting user based on the selected user's clearance settings. For example, a user in a corporate hierarchy may specify the users or user positions that may have access to their network conversations. As such, a user with a lower clearance may then be restricted from adding a selected user to a user roster or a network conversation. In another example, the selected user may have previously established criteria for accessibility such as the number of times the user may be notified of a pending or in progress network conversation, time limitations, date restrictions, the hierarchical position of the requesting user and/or a combination of such criteria. In addition, the activity of the selected user may determine whether the selected user may join the network conversation. For example, certain activities such as the user's participation in other network conversations, the number of keystrokes by a selected user over a period of time and/or other criteria may determine whether a user may be added to a network conversation. Various applications, such as Advertising Supported Software (i.e., spyware) for example, are known in the art for monitoring the activity of a user at a terminal and reporting such activity to a server or other location on a network. In one embodiment, predetermined thresholds of network activity may be used to determine whether a user may be added to a network conversation. Conversely, these pre-determined thresholds may also be utilized to disassociate a user from a network conversation. If the selected user is accessible to the requesting user then, at 408, the server processor 206 associates the one or more selected users with the network conversation.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention.

What is claimed is:

1. A method of selecting users to join a network conversation, comprising:
determining a subject of a network conversation; and
correlating said subject with subject matter criteria to determine at least one selected user who is or would be interested in said conversation.

2. The method of claim 1 wherein said determining of a subject of a network conversation comprises:
determining whether a conversation is associated with a subject; and
weighting the relevance of said conversation to said subject.

3. The method of claim 2 wherein the determining of whether a conversation is associated with a subject includes monitoring a subject indicator for at least one message of said conversation.

4. The method of claim 2 wherein the determining of whether a conversation is associated with a subject includes monitoring the dialogue of at least one message of said conversation.

5. The method of claim 2 wherein the determining of whether a conversation is associated with a subject includes monitoring an address for at least one message of said conversation.

6. The method of claim 1 further comprising indexing said conversation in association with at least one subject.

7. The method of claim 1 further comprising determining the subject matter criteria.

8. The method of claim 1 further comprising sending at least one message to said at least one selected user concerning said conversation.

9. The method of claim 8 wherein said at least one message invites said at least one selected user to join said conversation.

10. The method of claim 8 wherein said at least one message invites said at least one selected user to join a roster.

11. The method of claim 8 wherein said at least one message invites said at least one selected user to join a multiple user session.

12. The method of claim 1 further comprising automatically generating a roster including said at least one selected user based on said conversation.

13. The method of claim 1 further comprising automatically generating a multiple user session including said at least one selected user based on said conversation.

14. The method of claim 1 wherein said network conversation is an electronic mail conversation.

15. The method of claim 1 wherein said network conversation is a teleconference.

16. The method of claim 1 wherein said network conversation is an instant messaging conversation.

17. An apparatus for facilitating network conversation, comprising:
at least one processors said at least one processor for associating a network conversation with at least one subject and correlating said at least one subject with subject matter criteria to determine at least one selected user who is or would be interested in a particular conversation.

18. The apparatus of claim 17, wherein said at least one processor determines whether a particular conversation is associated with a subject; and weighs the relevance of said conversation to said subject.

19. The apparatus of claim 18 wherein said at least one processor determines whether a particular conversation is associated with a subject from a subject indicator for said conversation.

20. The apparatus of claim 18 wherein said at least one processor determines whether a particular conversation is associated with a subject from the dialogue of said conversation.

21. The apparatus of claim 18 wherein said at least one processor determines whether a particular conversation is associated with a subject from an address for said conversation.

22. The apparatus of claim 17 wherein said at least one processor indexes a particular conversation in association with at least one subject.

23. The apparatus of claim 17 wherein said at least one processor determines the subject matter criteria.

24. The apparatus of claim 17, wherein said subject matter criteria is pre-selected by a user.

25. The apparatus of claim 17 wherein said at least one processor sends at least one message to said at least one selected user concerning a particular conversation.

26. The apparatus of claim 17 wherein said at least one processor sends at least one message to invite said at least one selected user to join a roster.

27. The apparatus of claim 17 wherein said at least one processor automatically generates a roster including said at least one selected user based on a particular conversation.

28. The apparatus of claim 17 wherein said at least one processor automatically generates a multiple user conversation including said at least one selected user based on a particular conversation.

29. The apparatus of claim 28 wherein said at least one processor generates at least one message to inform said at least one selected user that they have been added to a multiple user conversation.

30. The apparatus of claim 17 wherein said particular conversation is an email conversation.

31. The apparatus of claim 17 wherein said particular conversation is a teleconference.

32. The apparatus of claim 17 wherein said particular conversation is an instant messaging conversation.

33. A computer-readable medium having computer executable instructions for:
determining whether a network conversation is associated with a subject;
weighting the relevance of said conversation to said subject;
correlating said weighting and said subject with pre-selected subject matter criteria to determine at least one selected user who is or would be interested in said conversation; and
associating said at least one selected user with said conversation.

34. The computer-readable medium of claim 33 wherein said computer executable instructions index said conversation in association with said subject.

35. The computer-readable medium of claim 33, wherein said computer executable instructions automatically add said at least one selected user to said conversation.

36. The computer-readable medium of claim 33 wherein said computer executable instructions automatically generate a roster including said at least one selected user based on said conversation.

37. The computer-readable medium of claim 33 wherein said computer executable instructions automatically generate a multiple user session including said at least one selected user based on said conversation.

38. The computer-readable medium of claim 33, wherein said computer executable instructions pre-select said subject matter criteria.

39. A system for facilitating a conversation over a digital medium comprising:
a plurality of clients; and
a at least one server for receiving a conversation from at least one of said plurality of clients, associating said conversation with at least one subject, and correlating said at least one subject with subject matter criteria to determine at least one selected user who is or would be interested in said conversation.

40. The system of claim 39 wherein said at least one server indexes said conversation in association with at least one subject.

41. The system of claim 39 wherein said at least one server determines the status of said at least one selected user, and when said status is within pre-selected parameters, associates said at least one selected user with said conversation.

42. The system of claim 39, wherein said at least one server determines the status of said at least one selected user, and when said status is not within pre-selected parameters, preventing said at least one selected user from joining said conversation.
